(19) United States
(12) Patent Application Publication
(10) Pub. No.: US 2024/0177637 A1
(43) Pub. Date: May 30, 2024

(54) ILLUMINATION REDISTRIBUTOR FOR DISPLAY PANEL

(71) Applicant: Meta Platforms Technologies, LLC, Menlo Park, CA (US)

(72) Inventors: Shenglin Ye, Santa Clara, CA (US); Xinyu Zhu, San Jose, CA (US); Yu-Jen Wang, Redmond, WA (US); Xiangtong Li, San Jose, CA (US)

(21) Appl. No.: 18/120,744

(22) Filed: Mar. 13, 2023

Related U.S. Application Data
(60) Provisional application No. 63/428,697, filed on Nov. 29, 2022.

(51) Int. Cl. G09G 3/00; G02B 27/01; G02B 27/30; G02F 1/1335

(52) U.S. Cl. CPC G09G 3/003; G02B 27/0172; G02B 27/30; G02F 1/133607

(57) ABSTRACT

Narrowing of an eyebox in a display including a display panel and an ocular lens caused by uniform illumination of the display panel may be reduced by using a redistributor that provides a spatially variant angular distribution of brightness matched to performance of the ocular lens. When a beam of light from a pixel of the display panel has a first dependence of a beam coordinate at the image plane upon a pixel coordinate at the object plane when the display panel is illuminated with light having a spatially uniform angular distribution of brightness, the redistributor may be configured to convert the spatially uniform angular distribution of brightness of light illuminating the display panel into a spatially non-uniform angular distribution of brightness for lessening the first dependence.

### REFERENCE TO RELATED APPLICATION

This application claims priority from U.S. Provisional Patent Application No. 63/428,697 entitled “Illumination Redistributor for Near-Eye Display”, filed on Nov. 29, 2022, and incorporated herein by reference in its entirety.

### TECHNICAL FIELD

The present disclosure relates to illuminators, and in particular illuminators for illuminating display panels, and related optical assemblies and display systems.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such s near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in a VR system, a liquid crystal display may be used to provide images of virtual objects viewed through an ocular lens.

Because a display of HMD or NED is usually worn on the head of a user, a large, bulky, unbalanced, and/or heavy display device with a heavy battery would be cumbersome and uncomfortable for the user to wear. Consequently, display units of an NED need to be compact and efficient. A close placement of optical components in a display unit may cause aberrations, distortions, vignetting, etc., resulting in worsening of quality of the displayed image.

### BRIEF DESCRIPTION OF THE DRAWINGS

Exemplary embodiments will now be described in conjunction with the drawings, in which:

FIG. 1 is a reverse ray-traced view of a near-eye display (NED) with a pancake lens collimator;

FIG. 2A is a schematic view of an NED with a compact collimator, with the optical rays traced from an eyebox of the NED back to a display panel of the NED;

FIG. 2B is a schematic view of the NED of FIG. 2A, with the optical rays traced from the display panel to the eyebox, illustrating a lack of alignment of collimated light beams at the eyebox;

FIG. 3 is a schematic side view of a single pixel of a transmissive display panel illuminated with light having different local angular distributions of brightness;

FIG. 4 is a schematic side view of an illuminator using an illumination redistributor for creating a spatially varying angular distribution of brightness of the illuminating light;

FIG. 5A is a schematic view of an NED with the display panel illuminated with light having spatially uniform angular distribution of brightness and a reduced eyebox size;

FIG. 5B is a schematic view of the NED of FIG. 5A with the display panel illuminated with the illuminator of FIG. 4 having spatially varying angular distribution of brightness of illuminating light for recovering the eyebox size;

FIG. 6A is a side cross-sectional view of an embodiment of an illumination redistributor of this disclosure;

FIG. 6B is a plan view of the illumination redistributor embodiment of FIG. 6A;

FIG. 7A is a microphotograph of a side profile of a prototype of the redistributor of FIGS. 6A and 6B;

FIG. 7B is a schematic view of a single triangular ridge of the side profile of FIG. 7A illustrating a light beam deviation by the ridge;

FIG. 8 is a graph of a ridge steepness vs. distance from the center of the illumination redistributor of FIGS. 6A and 6B for two embodiments of this disclosure;

FIG. 9 is a graph of a ridge pitch vs. distance from the center of the illumination redistributor of FIGS. 6A and 6B;

FIG. 10 is a graph of a ridge height vs. distance from the center of the illumination redistributor of FIGS. 6A and 6B, for two embodiments of this disclosure;

FIG. 11 is a graph of a measured angular brightness distribution downstream of an illumination redistributor prototype at several distances from the center of the redistributor;

FIG. 12A is a side cross-sectional view of a display panel with uniform lateral distribution of output light cones;

FIG. 12B is a side cross-sectional view of a display panel with a non-uniform lateral distribution of the output light cones provided by an illumination redistributor of this disclosure;

FIG. 13A is a side cross-sectional view of an embodiment of an illumination redistributor element having downward-facing straight light redirecting features;

FIG. 13B is a side cross-sectional view of an embodiment of an illumination redistributor element having upward-facing straight light redirecting features;

FIG. 13C is a side cross-sectional view of an embodiment of an illumination redistributor element having downward-facing curved light redirecting features;

FIG. 13D is a side cross-sectional view of an embodiment of an illumination redistributor element having upward-facing curved light redirecting features;

FIG. 13E is a side cross-sectional view of several embodiments of an illumination redistributor element with concave light redirecting features;

FIG. 13F is a side cross-sectional view of an embodiment of an illumination redistributor element with double-sided straight light redirecting features;

FIG. 13G is a side cross-sectional view of an embodiment of an illumination redistributor element with double-sided straight and curved light redirecting features;

FIG. 14 is a topographic view of several examples of illumination redistributor elements of this disclosure;

FIG. 15 is a view of a wearable display of this disclosure having a form factor of a pair of eyeglasses; and

FIG. 16 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

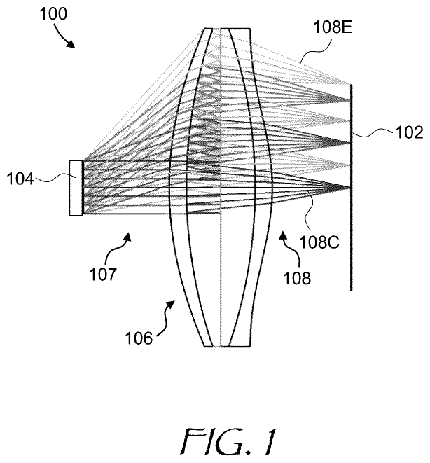

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1 to 7A-7B and 12A-12B, similar reference numerals denote similar elements.

Near-eye displays based on miniature display panels may use collimating lenses, also termed ocular lenses, with a large field, high numerical aperture, and/or short working distance to provide detailed wide-field views in a very compact display size. Such lenses often do not behave like ideal lenses. An ideal lens would convert an image in linear domain provided by the microdisplay panel into an image in angular domain for direct viewing by a user of the display. In other words, an ideal lens would operate as an offset-to-angle element. An ideal lens would also operate as an angle-to-offset element, converging all rays of a same ray angle, regardless of their locations on the microdisplay panel, to a same point at the display's eyebox where the viewer's eye may be located. The high-NA/large field lenses frequently deviate from this behavior, converging rays of a same angle to a different location at the eyebox, depending on the ray's coordinate, i.e. the ray's location at the microdisplay surface. This causes an undesired effect of reduction of eyebox size, requiring a precise placement of the user's eye in the eyebox to avoid vignetting of the viewed image. A requirement of precise eye placement may be inconvenient and/or impractical in a wearable display, being it for recreational, educational, or professional purposes.

In accordance with this disclosure, an illumination redistributor or redirector element may be provided that redirects illumination of a display panel in a pre-determined spatially-selective manner. The illumination redistributor element may be configured to offset an imperfection of a particular ocular lens, to pre-tilt illuminating rays causing the rays transmitted through a microdisplay panel at different locations on the panel to converge to a same location at the eyebox, thereby widening the eyebox of the display device and avoiding vignetting, making the display device much more practical and easy to use.

In accordance with the present disclosure, there is provided a display apparatus comprising a collimator having object and image planes, a display panel comprising an array of pixels for providing an image in linear domain at the object plane, and a redistributor comprising an array of light-redirecting features. The collimator is configured to convert the image in linear domain at the object plane into an image in angular domain at the image plane. A beam of light from a pixel of the display panel has a first dependence of a beam coordinate at the image plane upon a pixel coordinate at the object plane when the display panel is illuminated with light having a spatially uniform angular distribution of brightness. The light-redirecting features of the redistributor are configured to convert the spatially uniform angular distribution of brightness of light illuminating the display panel into a spatially non-uniform angular distribution of brightness so as to lessen the first dependence.

In embodiments where the display apparatus further includes an illuminator for providing the light having the spatially uniform angular distribution of brightness, the redistributor may be disposed downstream of the illuminator for converting the spatially uniform angular distribution of brightness into the spatially non-uniform angular distribution of brightness of the light illuminating the display panel. The collimator may comprise a pancake lens, for example.

In embodiments where the array of light-redirecting features of the redistributor comprises concentric circular ridges extending from a substrate, the concentric circular ridges may have e.g. triangular cross sections, a steepness of the triangular cross sections increasing with a distance from a common center of the concentric circular ridges. Each triangular cross-section may include a first side forming a first angle with a plane of the substrate, the first angle increasing with a distance from a center of the concentric circular ridges, and a second side joining the first side at a crest of the triangular cross-section, the second side forming a second angle with the plane of the substrate, the second angle being greater than 80 degrees and less than 89.9 degrees. In some embodiments, second angle is greater than 87 degrees and less than 89 degrees. In some embodiments, a height of each triangular cross section may be no greater than 30 micrometers; a pitch of the array of light-redirecting features may be between 5 micrometers and 100 micrometers; the pitch may vary with the distance from the center, with a minimum variation of 30 nanometers between neighboring ridges; and/or the redistributor may include a flat central region of a uniform thickness.

In accordance with the present disclosure, there is provided a matched collimator-redistributor pair comprising a collimator for converting a cone of light from each pixel of a display panel at an object plane of the collimator into a corresponding collimated beam at an image plane of the collimator, where a coordinate of the collimated beam at the image plane has a dependence on a coordinate of a corresponding pixel at the object plane, and a redistributor comprising an array of light-redirecting features for providing a lateral distribution of a local direction of illuminating light of an illuminator for illuminating the display panel to lessen the dependence of the coordinate of the collimated beam at the image plane on the coordinate of the corresponding pixel at the object plane.

In embodiments where the coordinate of the collimated beam at the image plane has the dependence on the coordinate of the corresponding pixel at the object plane when all cones of light from all pixels of the display panel have cone axes parallel to one another, the redistributor may be configured to reorient the cone axes of at least some of the pixels to lessen the dependence of the coordinate of the collimated beam at the image plane on the coordinate of the corresponding pixel at the object plane. The collimator may include a pancake lens, for example. The array of light-redirecting features of the redistributor may include concentric circular ridges extending from a substrate. The concentric circular ridges may have triangular cross sections, a steepness of the triangular cross sections increasing with a distance from a common center of the concentric circular ridges. Each triangular cross-section may include a first side forming a first angle with a plane of the substrate, the first angle increasing with a distance from a center of the concentric circular ridges, and a second side joining the first side at a crest of the triangular cross-section.

In some embodiments, the second angle is greater than 87 degrees and less than 89 degrees; a height of each triangular cross section is no greater than 30 micrometers; a pitch of the array of light-redirecting features is between 5 micrometers and 100 micrometers, the pitch optionally varying with the distance from the center, with a minimum variation of 30 nanometers between neighboring ridges; and/or the redistributor comprises a flat central region of a uniform thickness.

In accordance with the present disclosure, there is further provided a redistributor for converting a first lateral angular distribution of brightness of an illuminator into a second, different lateral angular distribution of brightness of the illuminator. The redistributor comprises a transmissive substrate and a first array of refractive features extending from the transmissive substrate. The redistributor may further comprise a flat central region of a uniform thickness. The refractive features of the first array may have triangular or convex cross sections with a steepness of the cross sections increasing with a distance from a center of the transmissive substrate.

The first array of refractive features may include concentric circular ridges. The refractive features of the first array may have triangular cross sections, a steepness of the triangular cross sections increasing with a distance from a common center of the concentric circular ridges. Each triangular cross-section may include a first side forming a first angle with a plane of the transmissive substrate, the first angle increasing with a distance from a center of the concentric circular ridges, and a second side joining the first side at a crest of the triangular cross-section and forming a second angle with the plane of the transmissive substrate.

In some embodiments, second angle is greater than 87 degrees and less than 89 degrees, a height of each triangular cross section is no greater than 30 micrometers, and/or pitch of the first array is between 5 micrometers and 100 micrometers. In some embodiments, the pitch may vary with the distance from the center, with a minimum variation of 30 nanometers between neighboring ridges.

Referring now to FIG. 1, a display apparatus 100 includes a display panel 102 viewed an eye at an eyebox 104 through an ocular lens 106, in this embodiment a so-called pancake lens. A pancake lens includes reflective and refractive elements having optical power, and folds light path within the pancake lens by polarization, resulting in a very compact overall configuration allowing wide views at a short distance from the pancake lens. The ocular lens 106 conveys image light 108 provided by the display panel 102 to the eyebox 104. Ray cones including a central cone 108C and an edge cone 108E are obtained by tracing collimated image beams 107 backwards from the eyebox 104 to the display panel 102 using optical design software. The optical design software suitably originates the rays at the eyebox location as sets of parallel rays, each set of parallel rays having a different ray angle, and traces the ray sets towards the display panel 102. The radiae of curvature and the inter-layer distances in the pancake lens 106 are numerically optimized to meet target criteria related to the required field of view, focal length, modulation transfer function, etc., of the ocular lens 106. The rationale of such an optimization is that, since the light propagation is reciprocal, the rays in an actual display will backtrack the reverse propagated simulated rays, ensuring in the required performance of the display apparatus 100.

When the optimization converges to a sought-for solution, the optimization targets are met to within acceptable tolerance limits. However, the end result often is that the light cones converge on the display panel 102 at somewhat oblique angles, i.e. away from surface normal, or in other words not at 90 degrees to the plane of the display panel 102. This is illustrated in FIG. 1 where the reverse-traced edge cone 108E impinges onto the display panel 102 away from a normal angle of incidence as compared, for example, to the central cone 108C which does impinge orthogonally due to axial symmetry of the ocular lens 106. Light cones at intermediate locations between the central 108C and edge 108E cones will have a smoothly varying distribution of angles of incidence onto the display panel 102. For certainty, the term “angle of incidence”, when applied to a converging or diverging light beam, or a light cone, is related to the angle of incidence of a chief ray of the light cone. The specific distribution of the angles of incidence depends on a particular lens implementation, and may occur not only for pancake lenses but also for other types of lenses known to persons skilled in the art, e.g. multi-element refractive lenses.

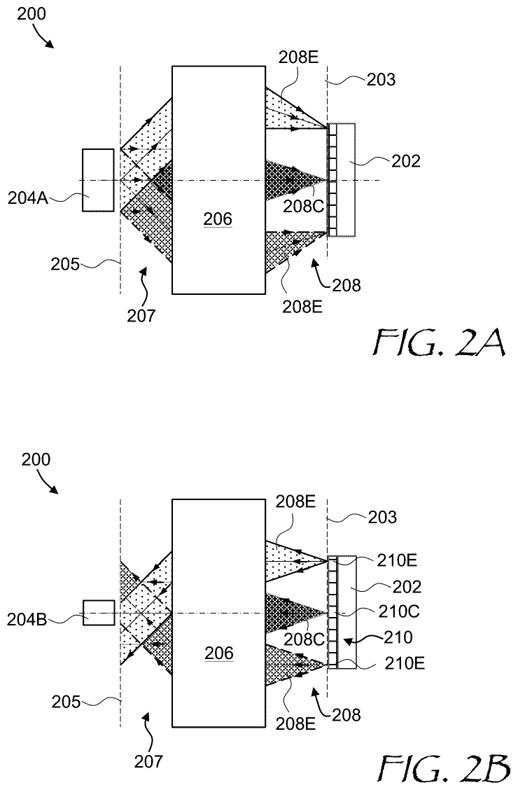

Referring to FIG. 2A, a more generic case of a display apparatus 200 is illustrated in a side schematic view. The display apparatus 200 includes a display panel 202 viewed by an eye at an eyebox 204A through an ocular lens or collimator 206, which is shown in FIG. 2A as a solid rectangle. The collimator 206 may include any types of focusing/defocusing elements, including refractive, reflective, diffractive elements, pancake lenses and their elements or derivatives, etc. The display panel 202 is disposed at an object plane 203 of the collimator 206, and the eyebox 204A is disposed at an image plane 205 of the collimator 206. Sets of parallel rays 207 are traced backwards, i.e. from the eyebox 204A to the display panel 202, resulting in ray cones or cones of light 208 including edge ray cones 208E and a center ray cone 208C having their apices located at the display panel 202. The edge ray cones 208E are skewed, similarly to the edge cones 108E in FIG. 1. The edge ray cones 208E may be skewed in either direction. The direction and the magnitude of the skewing depends on the specific configuration of the collimator 206. For axially symmetrical collimators 206, i.e. for collimators with axially symmetrical refractive and/or reflective surfaces, the skew angle distribution of the light cones is also axially symmetric.

Turning to FIG. 2B, the display panel 202 includes an array of pixels 210, including a center pixel 210C and edge pixels 210E. The pixels 210 emit beams cones of rays 208 represented by the central ray cone 208C emitted by the central pixel 210C, the edge ray cones 208E emitted by edge pixels 210E. In this embodiment, all ray cones are oriented parallel to one another and normal to the object plane 203 because the beams of light emitted by different pixels of the pixel array 210 have a same angular distribution of brightness. Since the angular distribution of brightness of the central 208C and edge 208E ray cones is different in FIG. 2B as compared to FIG. 2A, the rays 207 in FIG. 2B do not converge to same locations at the image plane 205 as in FIG. 2A. Rather, the collimated beams corresponding the edge ray cones 208E are displaced at the image plane 205 from the on-axis collimated beam corresponding to the center ray cone 208C, as shown in FIG. 2B. The rays offset causes the reduction of an eyebox 204B size in vertical direction in FIG. 2B. If, for example, the viewer's eye were placed outside of the eyebox 204B but inside the bounds of the eyebox 204A, the viewer would have noticed that the displayed image is vignetted on one side. The shrinkage of the eyebox size caused by the straight ray cones emitted by the display panel is undesirable, and needs to be mitigated.

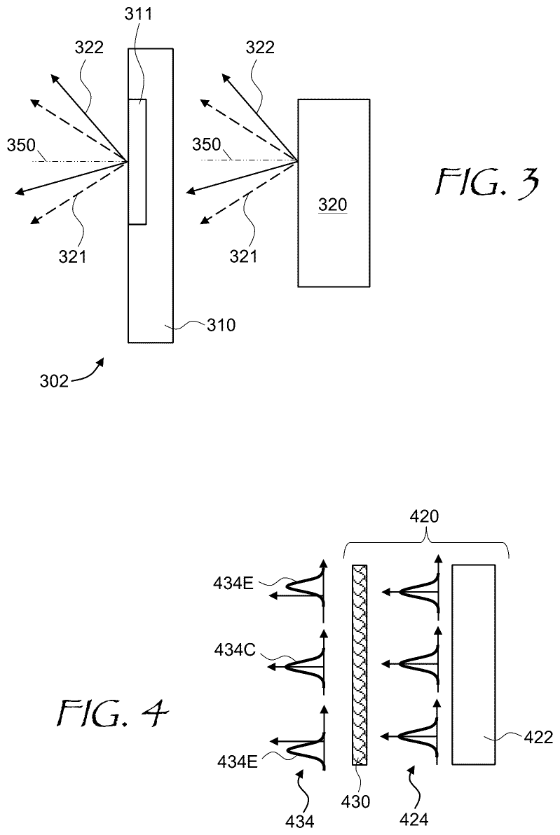

In accordance with this disclosure, the angular distribution of brightness of a display panel may be made spatially variant to match the one illustrated in FIG. 2A, which offsets or reduces the eyebox shrinkage caused by collimator imperfection. Referring to FIG. 3, a display panel 302 includes a transmissive pixel array 310 illuminated by an illuminator 320. Only one pixel 311 of the transmissive pixel array 310 is shown in FIG. 3 for brevity. The illuminator 320 has a first angular distribution of brightness 321, which is symmetrical w.r.t. a normal 350 to a light-emitting surface of the illuminator 320. The first angular distribution of brightness 321 is shown with dashed lines. When the transmissive pixel array 310 is illuminated with the first angular distribution of brightness 321, the pixel 311 of the transmissive pixel array 310 also has the first angular distribution of brightness 321 of the image light. The illuminator 320 may have a second angular distribution of brightness 322, which is skewed w.r.t. the illuminator's 320 surface, forming an acute angle with the normal 350. The second angular distribution of brightness 322 is shown with solid lines. When the transmissive pixel array 310 is illuminated with the second angular distribution of brightness 322, the pixel 311 of the transmissive pixel array 310 will also have the second distribution of brightness 322. Therefore, the angular distribution of brightness of a display panel may be made spatially variant by providing an illuminator having a required pre-defined spatially variant angular distribution of brightness of illuminating light.

FIG. 4 shows one embodiment of such an illuminator 420. The illuminator 420 includes an illumination panel 422 having a spatially uniform angular distribution of brightness, i.e. the first distribution 321 in FIG. 3. In FIG. 4, the spatially uniform angular distribution of brightness is represented by a bell-shaped distribution function 424 centered about a zero angle w.r.t. the surface normal of the illumination panel 422. In other words, most of the light emitted by the illumination panel is directed perpendicular to the panel's surface, from a point of the panel's surface. The illuminator 420 further includes an illumination redistributor 430, which converts the spatially uniform, angularly symmetrical angular distribution of brightness 424 of the illuminating light into a desired spatially non-uniform angular distribution of brightness 434. At a center of the illumination redistributor 430, a center angular distribution of brightness 434C coincides with the surface normal of the illumination panel 422. At edges of the illumination redistributor 430, an edge angular distribution of brightness 434E is offset from surface normal of the illumination panel 422, i.e. forms an acute angle with the surface normal of the illumination panel 422. The spatial variance of the angular distribution of brightness may be selected to match the angular distribution of the ray cones 208 shown in FIG. 2A. For axially symmetric collimators, the spatial variance of the angular distribution of brightness may also be axially symmetric. Matching the angular distribution of the ray cones allows one to widen the eyebox of the display apparatus 200, by causing the rays of light emitted by the display panel 202 to retrace the optical path of the ray cones 208 and the parallel rays 207 shown in FIG. 2A.

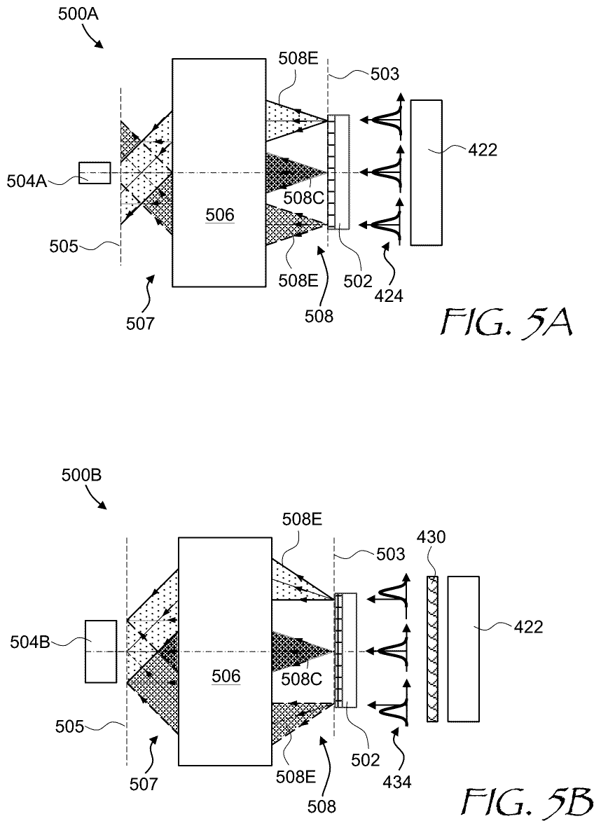

The latter point is further illustrated in FIGS. 5A and 5B. FIG. 5A depicts a display apparatus 500A, which is similar to the display apparatus 200 of FIGS. 2A and 2B. The display apparatus 500A of FIG. 5A includes a transmissive display panel 502 viewed by an eye at an eyebox 504A through an ocular lens or collimator 506 shown as a solid rectangle. The collimator 506 has object 503 and image 505 planes. The transmissive display panel 502 is disposed in the object plane 503. The transmissive display panel 502 is illuminated by the illumination panel 422 having the spatially uniform angular distribution of brightness. As in FIG. 4, the spatially uniform angular distribution of brightness is represented in FIG. 5 by the bell-shaped distribution function 424 symmetrical about the surface normal of the illumination panel 422. Corresponding beams or cones of light 508 from pixels of the transmissive display panel 502A are also straight. In other words, both center 508C and edge 508E beams or cones of light are centered about the surface normal of the transmissive display panel 502A, causing a reduction of size of an eyebox 504A disposed in the image plane 505 due to misalignment of collimated light beams 507 in a similar manner as was explained above with reference to FIG. 2B.

Turning now to FIG. 5B, a display apparatus 500B is similar to the display apparatus 500A of FIG. 5A, and includes the same elements as the display apparatus 500A of FIG. 5A. The display apparatus 500B of FIG. 5B further includes the illumination redistributor 430 disposed downstream of the illumination panel 422 in an optical path between the illumination panel 422 and the transmissive display panel 502. The illumination redistributor 430 converts the spatially uniform angular distribution of brightness 424 of the illuminating light into the desired spatially non-uniform angular distribution of brightness 434, as explained above with reference to FIG. 4. The spatially non-uniform angular distribution of brightness 434 causes the edge cones of light 508E to be tilted outwards, while the center cone of light 508C remains centered. The illumination redistributor 430 is configured to convert the spatially uniform angular distribution of brightness 424 of light illuminating the display panel 502 into a spatially non-uniform angular distribution of brightness 434 in such a manner as to lessen the dependence of a beam coordinate at the image plane 505 upon a pixel coordinate at the object plane 503 when the display panel 502 is illuminated with light having the spatially uniform angular distribution of brightness 424, i.e. when all cones 508 of light from all pixels of the transmissive display panel 502 have cone axes parallel to one another. As can be seen by comparing the display apparatus 500B of FIG. 5B to the display apparatus 500A of FIG. 5A, using the illumination redistributor 430 in the display apparatus 500B allows one to increase the eyebox 504B size by reorienting the cone axes and compensating the dependence of the beam coordinate at the image plane 505 upon the pixel coordinate at the object plane 503.

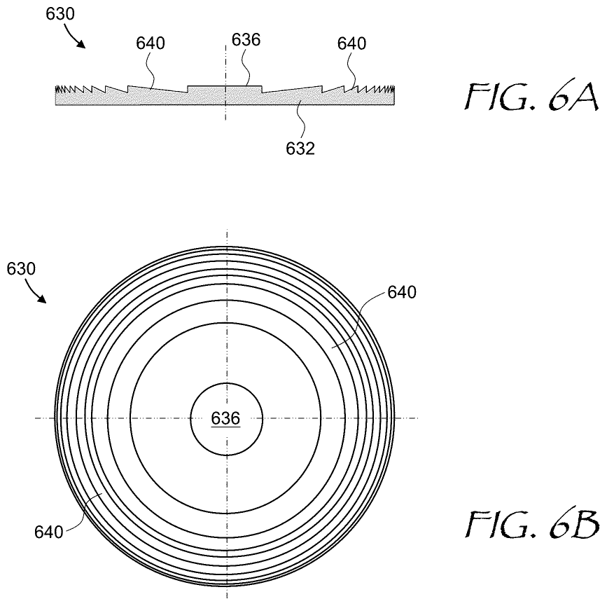

Non-limiting examples of the illumination redistributor 430 will now be considered. Referring to FIGS. 6A and 6B, an illumination redistributor 630 may be used in the display apparatus 500B of FIG. 5B. The illumination redistributor 630 includes a substrate 632 and an array of axially symmetric light redirecting features 640 extending from the substrate 632. In the example illustrated, the substrate 632 is a round transmissive substrate having one flat surface and one ridged surface (i.e. the surface including the light redirecting features 640) opposite the flat surface. The light redirecting features 640 are circular and concentric in the plan view of FIG. 6B, and have triangular cross sections in the side view of FIG. 6A. The steepness of the cross sections of the light redirecting features 640 increases with the radial distance, and the pitch of the cross sections of the light redirecting features 640 decreases with the radial distance. A flat central region 636 may be disposed at the center of the illumination redistributor 630. The flat central region 636 may have a form of a circular slab concentric with the light redirecting features 640 in the plan view of FIG. 6B. The flat central region 636 may have a uniform thickness, i.e. it may be flat and parallel to the substrate 632.

The slope, pitch, and location of the light redirecting features 640 may be selected to lessen the dependence of the beam coordinate at the image plane 505 (FIG. 5B) upon the pixel coordinate at the object plane 503 when the display panel 502 is illuminated with light having the spatially uniform angular distribution of brightness 424. Since the above mentioned dependence of the exit beam coordinate at the image plane on the pixel coordinate at the object plane is a characteristic of the collimator 506, the illumination redistributor 630 of FIGS. 6A and 6B may be configured, and may be produced and sold as, a matched collimator-redistributor pair. More generally, any illumination redistributor of this disclosure may be configured to match a particular collimator and may be manufactured and sold as a matched collimator-redistributor pair.

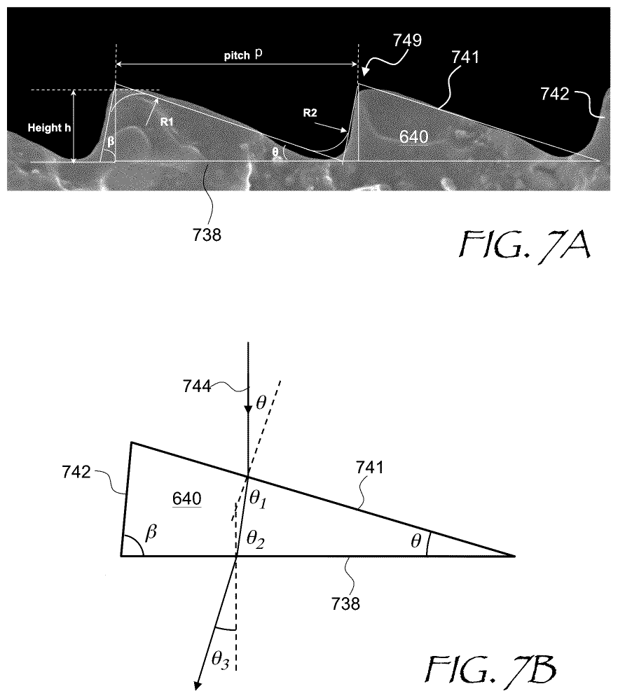

A micrograph of a prototype of the illumination redistributor 630 of FIGS. 6A and 6B is presented in FIG. 7A. The light redirecting features 640 have triangular cross sections characterized by a pitch p, a height h, a first side 741 forming a first angle θ with a plane 738 of the substrate 632, and a second side 742 forming a second angle β with the plane 738 of the substrate 632. The first side 741 and the second side 742 join each other at a crest 749. Due to manufacturing tolerances and minimal feature size limitations, radiae R1, R2 between the first 741 and second 742 sides of the triangular ridges 640 may be provided.

The light deflection by the light redirecting ridges 640 of the illumination redistributor 630 is illustrated in FIG. 7B. A light beam 744 impinges onto the first side 741 of the triangular ridge 640 at a straight angle to the plane 738 of the substrate, or at the first angle θ to the first side 741 of the triangular ridge 640. The light beam 744 is refracted at the first side 741 to propagate in the light redirecting features 640 at an angle θ₁. The light beam 744 is then impinges onto the second side 742 at an angle θ₂, is refracted at the second side 742 and exits the illumination redistributor 630 at an angle θ₃. From Snell's law and geometry, the angles θ, θ₁, θ₂, and θ₃ are related to one another as

n sin ϑ₁=sin ϑ

ϑ₂=ϑ−ϑ₁

sin ϑ₃=n sin ϑ₂ (1)

where n is a refractive index of the light redirecting features 640.

From Eqs. (1), the deviation angle θ₃ may be calculated. Table 1 below illustrates a dependence of the deviation angle θ₃ depends on the first angle θ for the refractive index n of 1.5.

TABLE 1

| | | | | |
|---|---|---|---|---|
| Input (first) angle θ | 10° | 20° | 30° | 37° |
| Output angle θ₃ | 5° | 10.3° | 15.9° | 20.3° |

It is seen that the deviation angle θ₃ depends on the first angle θ of the triangular light redirecting features 640. By varying the first angle θ₃ with a distance from the center of the illumination redistributor 630, the desired lateral distribution of a local direction of light provided by an illuminator, or in other words the desired angular distribution of brightness of the illuminator, may be achieved. The lateral distribution of the illumination direction may be selected to match to a particular collimator lens off-axis performance, to reduce vignetting effects and to increase the overall eyebox size as explained above with reference to FIGS. 5A and 5B.

In some embodiments, the second angle β may be selected to be less than 90 degrees, for the following reason. The second angle β of 90 degrees may create a discontinuity of the phase profile of the impinging light beam 744, which may cause undesired diffraction of the light beam 744. To prevent or reduce the diffraction, the second angle β may be in a range between 80 degrees and 89.9 degrees, or in a narrower range of between 87 degrees and 89 degrees.

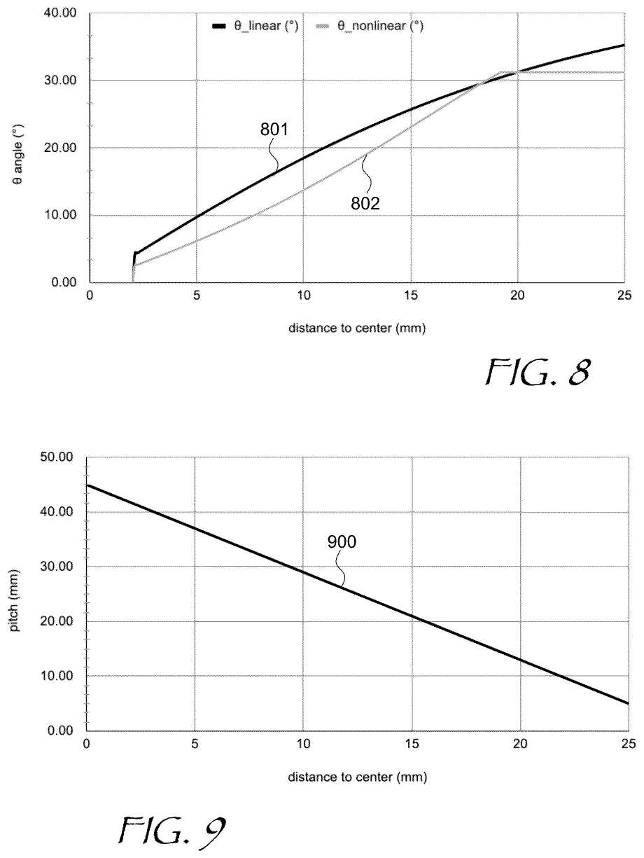

Referring now to FIG. 8 with further reference to FIGS. 6A and 6B, example radial distributions of the first angle θ between the plane 738 of the substrate 632 and the first side 741 of the triangular cross-sections of the light redirecting features 640 is plotted as a function of a distance from the center of the illumination redistributor 630 of FIGS. 6A and 6B, i.e. the common center of the concentric circular ridges or the light redirecting features 640. Two configurations are presented, a “linear” configuration 801, with a linear target dependence of the angular deviation θ₃ on the distance from the center, and a “nonlinear” configuration 802, with a nonlinear target dependence of the angular deviation θ₃ on the distance from the center. In both cases, the first angle θ representing the steepness of the triangular light redirecting features 640 increases with the distance from the common center of the concentric circular ridges 640.

FIG. 9 illustrates a dependence 900 of the pitch of the light redirecting features 640 as a function of the distance from the center. The pitch decreases linearly with the distance for both the linear and the nonlinear configurations. The decrease of the pitch is mostly caused by a practical consideration of limiting the height of the light redirecting features 640 across the entire surface of the illumination redistributor 630. In some embodiments, a range of between 5 micrometers and 100 micrometers may be used for the pitch of the array of light-redirecting features. A minimum variation of the pitch may be at least 30 nanometers between neighboring light-redirecting features (ridges) 640.

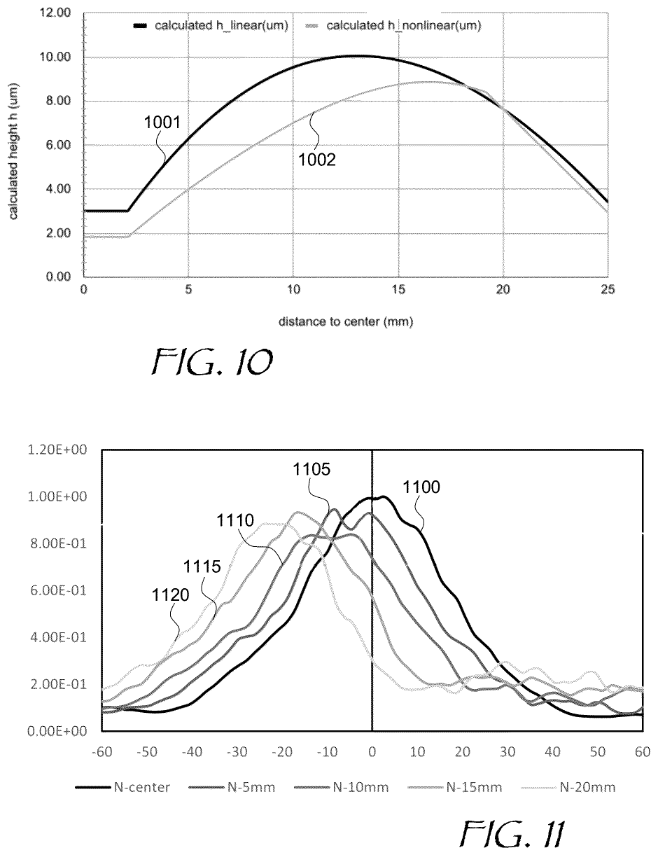

Turning to FIG. 10, a calculated height h of the light redirecting features 640 is plotted vs. the distance form the center for the linear configuration (a first curve 1001) and the non-linear configuration (a second curve 1002). It is seen that the height varies between two and ten micrometers, making the illumination redistributor 630 very compact, with the overall thickness being dominated by the substrate 632 thickness (FIG. 6A). In some embodiments, the height h of the light redirecting features 640 is no greater than 30 micrometers.

Referring now to FIG. 11 with further reference to FIGS. 4 and 6A-6B, angular brightness distributions of a prototype of the illumination redistributor 630 of FIGS. 6A and 6B have been measured at several distances from the center of the illumination redistributor 630. The illumination redistributor 630 has been illuminated with the illumination panel 422 in a geometry illustrated in FIG. 4. The illumination panel 422 has a spatially uniform angular distribution of brightness centered around the normal to the surface of the illumination panel 422 and represented by the bell-shaped distribution function 424. At the center of the illumination redistributor 630 (FIGS. 6A and 6B), the measured angular distribution of brightness is represented by a first curve 1100 (FIG. 11). The first curve 1100 is symmetrical because it represents the angular distribution of brightness of the illuminating light propagated through the flat central region 636 (FIGS. 6A and 6B). A second curve 1105 (FIG. 11) corresponds to the angular distribution of brightness 5 mm away from the center. The second curve 1105 is slightly offset from the center, indicating that the illuminating light is redirected outwards by the light redirecting features 632. A third curve 1110 corresponds to the angular distribution of brightness 10 mm away from the center. The third curve 1110 is offset from the center more than the second curve 1105. This trend continues for a fourth curve 1115 corresponding to 15 mm from the center, and for a fifth curve 1120 corresponding to the distance of 20 mm from the center. The trend is caused by the steepness of the redirecting feature 640 increasing with the distance from the center of the illumination redistributor 630.

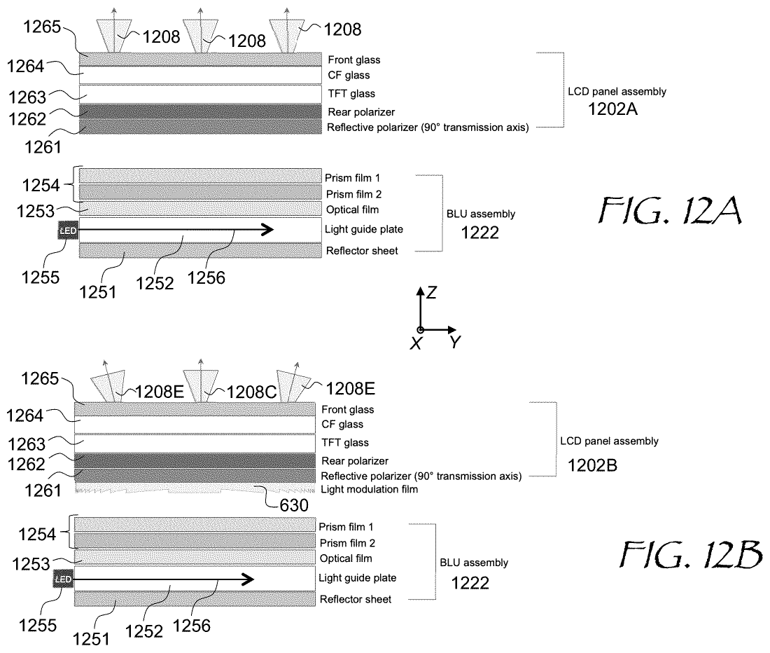

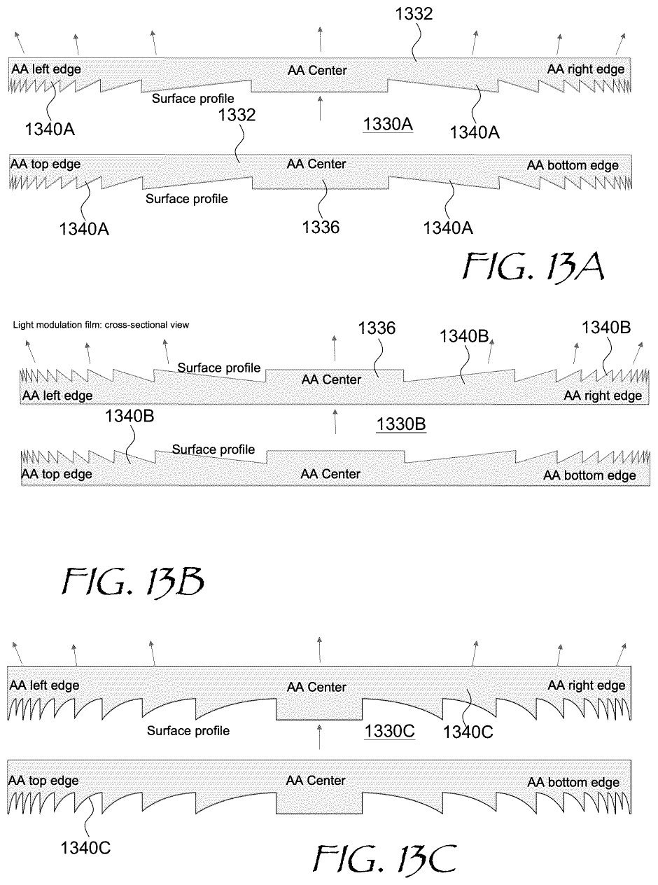

Referring now to FIG. 12A with further reference to FIG. 5A, a transmissive liquid crystal display (LCD) panel assembly 1202A is illuminated with a backlight unit (BLU) assembly 1222 providing a spatially uniform illumination with the angular distribution of brightness centered around a normal to the BLU assembly 1222. In this example, the BLU assembly 1222 comprises a stack of a reflector sheet 1251, a light guide plate 1252, an optical film 1253, and a couple of prismatic films 1254. In operation, a light-emitting diode (LED) 1255 emits light 1256 that is side-coupled into the light guide plate 1252, propagating in the light guide plate 1252 in Y-direction. Portions of the light 1256 are out-coupled from the light guide plate 1252 in Z-direction, propagating through the optical film 1253 and the two prismatic films 1254 towards the LCD panel assembly 1202A. The function of the optical film 1253 is to facilitate out-coupling of the light 1256 from the light guide plate 1252. The function of the prismatic films 1254 is to homogenize the angular distribution of brightness of the illuminating light.

The LCD panel assembly 1202A may include a reflective polarizer 1261 for recycling illuminating light, an optional rear polarizer 1262, a thin film transistor (TFT) glass 1263, a color filter (CF) glass 1264, and a front glass 1265 in this example. The TFT glass 1263 and the color filter glass 1264 form a cell filled with a liquid crystal fluid. The TFT glass forms the sets of voltages for driving liquid crystal pixels, and the color filter glass provides color filters for forming color sub-pixels of the LCD panel assembly 1202A. The optical film 1253 and the two prismatic films 1254 are optimized to provide the spatially uniform angular distribution 424 (FIG. 5A) of the illuminating light, which creates a spatially uniform angular distribution of image light as explained above with reference to FIG. 3. Herein, the term “spatially uniform” means that cones 1208 of the image light are oriented in a substantially same way across the entire surface of the LCD panel assembly 1222. The spatially uniform cones 1208 of the image light may cause the eyebox reduction and/or vignetting as explained above with reference to FIGS. 5A and 5B.

Turning to FIG. 12B with further reference to FIG. 5B and FIGS. 6A and 6B, a transmissive LCD panel assembly 1202B is illuminated with the BLU assembly 1222 of FIG. 12A. The transmissive LCD panel assembly 1202B of FIG. 12B is similar to the transmissive LCD panel assembly 1202A of FIG. 12A, and includes the same elements as the transmissive LCD panel assembly 1202A. The transmissive LCD panel assembly 1202B of FIG. 12B further includes the illumination redirector 630 of FIGS. 6A and 6B denoted as “light modulation film” in FIG. 12B. The illumination redirector 630 redirects the illumination light provided by the BLU assembly 1222 in a spatially-selective manner. The net result of using the illumination redirector 630 is that the main direction of light cones 1208 becomes dependent on the coordinate (XY coordinate) of the LCD panel assembly. In this non-limiting illustrative example, the edge light cones 1208E are tilted outwards, while the center light cone 1208C remains upright. The spatially-dependent main direction of the light cones 1208, which represent angular distributions of brightness, may be used to expand the eyebox as explained above with reference to FIGS. 5A and 5B.

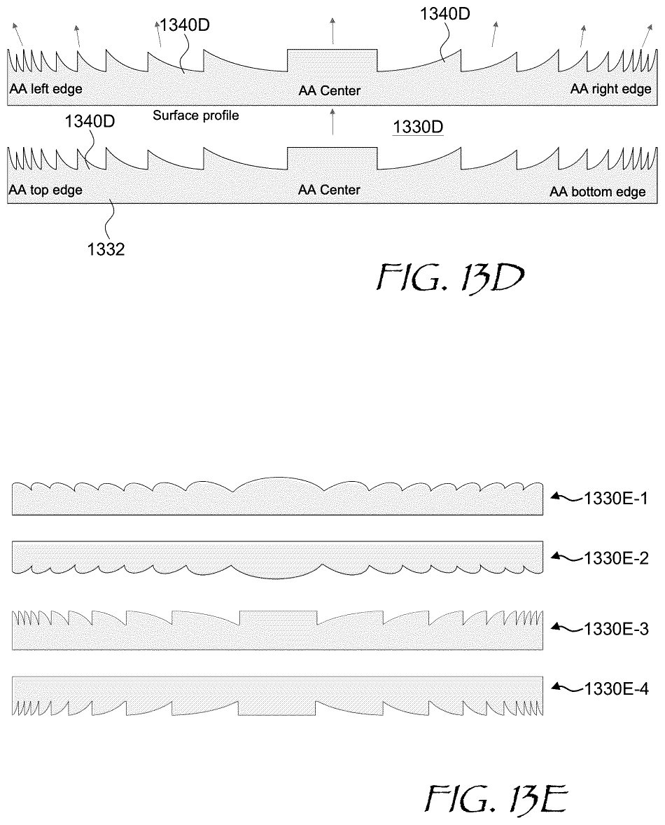

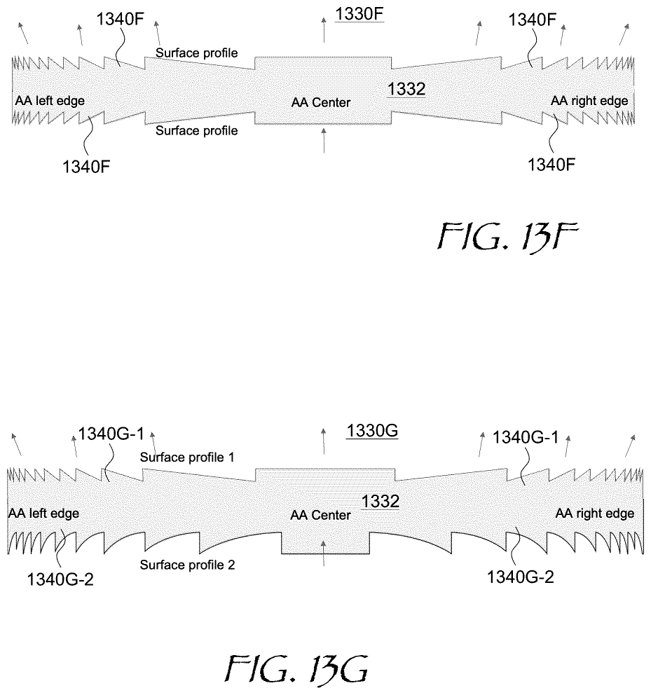

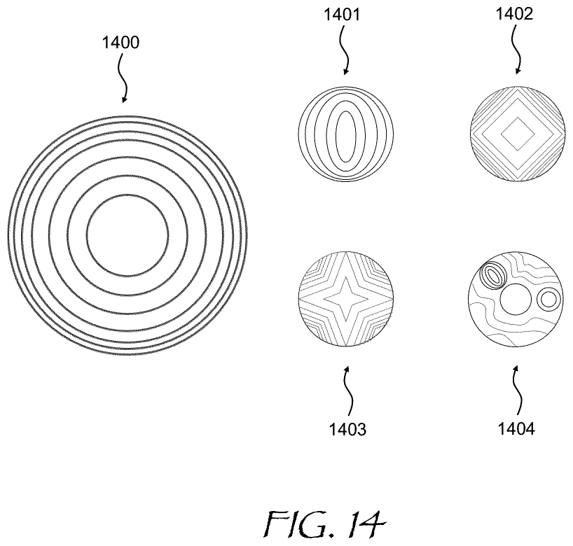

FIGS. 13A to 13G are non-limiting illustrative examples of possible variants of the light modulation film, or the illumination redirector for use in the transmissive LCD panel assembly 1202B of FIG. 12B, or in another transmissive or reflective illuminated display panel. FIG. 13A shows two cross-sections of an illumination redirector 1330A including a plurality of downward-facing straight or triangular refractive features 1340A across its active aperture (AA). In each of FIGS. 13A to 13D, the two shown cross sections are perpendicular to one another and include the central axis of the redistributor. The refractive features 1340A of FIG. 13A extend from a transparent substrate 1332 towards the illuminator panel disposed below the illumination redirector 1330A. The purpose of the refractive features 1340A is to redistribute or redirect homogeneous illumination of a display panel in a spatially-selective manner, thereby changing an angular distribution of illumination as explained above. In this specific example, the refractive features 1340A are prismatic elements with the steepness of the elements increasing with radial distance, to tilt the outward image light cones 1208 outward as shown in FIG. 12B. The prismatic elements may form a set of radial conical surfaces, with the local surface tilt increasing with the radial distance. The illumination redirector 1330A may further include a flat central region 1336.

Turning to FIG. 13B, an illumination redistributor 1330B is similar to the illumination redistributor 1330A of FIG. 13A, but with light redirecting features 1340B facing away from the light source, i.e. upwards in FIG. 13B. The refractive features 1340B have triangular cross sections, a steepness of the triangular cross sections increasing with a distance from the center of the illumination redistributor 1330B.

Referring now to FIG. 13C, an illumination redistributor 1330C is similar to the illumination redistributor 1330A of FIG. 13A. The illumination redistributor 1330C of FIG. 13C includes light redirecting features 1340C with concave slanted surfaces pointing downwards, i.e. towards the light source. The refractive features 1340C have concave cross sections, a steepness of the concave cross sections increasing with a distance from the center of the illumination redistributor 1330C.

Referring to FIG. 13D, an illumination redistributor 1330D is similar to the illumination redistributor 1330C of FIG. 13C, in that it includes light redirecting features 1340D with concave slanted surfaces. The illumination redistributor 1330D of FIG. 13D includes light redirecting features 1340D with concave slanted surfaces pointing upwards, i.e. away from the light source. The refractive features 1340D have concave cross sections, a steepness of the concave cross sections increasing with a distance from the center of the illumination redistributor 1330D.

Turning to FIG. 13E, a few more illumination redistributor embodiments are presented. A first illumination redistributor 1330E-1 includes a plurality of upward-facing convex lenslet refractive features, and/or concentric ridges having convex cross sections. A second illumination redistributor 1330E-2 includes a plurality of downward-facing convex lenslet refractive features or ridges. A third illumination redistributor 1330E-3 includes a plurality of upward-facing convex prismatic refractive features/ridges. A fourth illumination redistributor 1330E-4 includes a plurality of downward-facing convex prismatic refractive features/ridges.

Referring now to FIG. 13F, an illumination redistributor 1330F is similar to the illumination redistributor 1330A of FIG. 13A, in that it includes prismatic light redirecting features 1340F with triangular cross sections, which may form concentric conical rings. In the illumination redistributor 1330F of FIG. 13F, the prismatic light redirecting features 1340F extend from the transparent substrate 1332 both upstream and downstream of the illuminating light, i.e. both downwards and upwards.

Referring to FIG. 13G, an illumination redistributor 1330G is similar to the illumination redistributor 1330F of FIG. 13F, in that it includes light redirecting features 1340G-1 and 1340G-2 extending from the transparent substrate 1332 downstream and upstream respectively, i.e. upwards and downwards respectively. The upwards facing features 1340G-1 have triangular cross-sections, while the downward facing features 1340G-2 have concave cross-sections.

The lateral distribution of the transmissive light redirecting features may, but does not have to, be rotationally symmetric. For some ocular/collimator lenses, there may be no rotational symmetry but an axial symmetry or a symmetry about one or two planes or even no symmetry at all, as illustrated in FIG. 14. For example, a axial symmetry (1400), a two-plane symmetry (an elliptical embodiment 1401, a rhombic embodiment 1402, and a star embodiment 1403) may be present, or no symmetry at all may be present (an irregular embodiment 1404). In some variants, all the embodiments of FIGS. 13A-13G and FIG. 14 may have same or similar limitations on pitch, height, and steepness as the ones described above with reference to FIGS. 6A-6B, 7A-7B, and FIGS. 8-10.

It is to be understood that the illumination redirectors considered above are just non-limiting illustrative examples. Many other configurations are possible, with different types of redirecting features, which may be arranged into grooves, troughs, peaks, lenslets, ridges, conical/spherical/aspheric rings, etc.

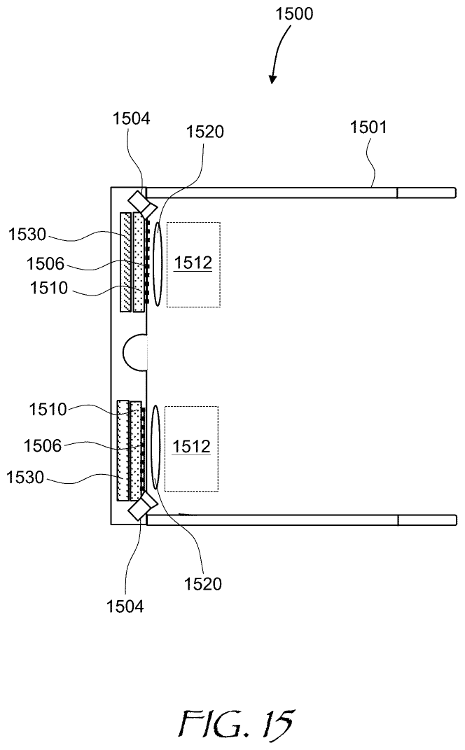

Referring to FIG. 15, a near-eye display 1500 has a form factor of a pair of glasses. The near-eye display 1500 includes a frame 1501 supporting, for each eye: an illuminator 1530 including any of the illuminators disclosed herein; a display panel 1510 including any of the display panels disclosed herein; and an ocular lens 1520 for converting the image in linear domain generated by the display panel 1510 into an image in angular domain for direct observation at an eyebox 1512. A plurality of eyebox illuminators 1506, shown as black dots, may be placed around the display panel 1510 on a surface that faces the eyebox 1512. An eye-tracking camera 1504 may be provided for each eyebox 1512.

The purpose of the eye-tracking cameras 1504 is to determine position and/or orientation of both eyes of the user. The eyebox illuminators 1506 illuminate the eyes at the corresponding eyeboxes 1512, allowing the eye-tracking cameras 1504 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1506, the latter may be made to emit light invisible to the user. For example, infrared light may be used to illuminate the eyeboxes 1512.

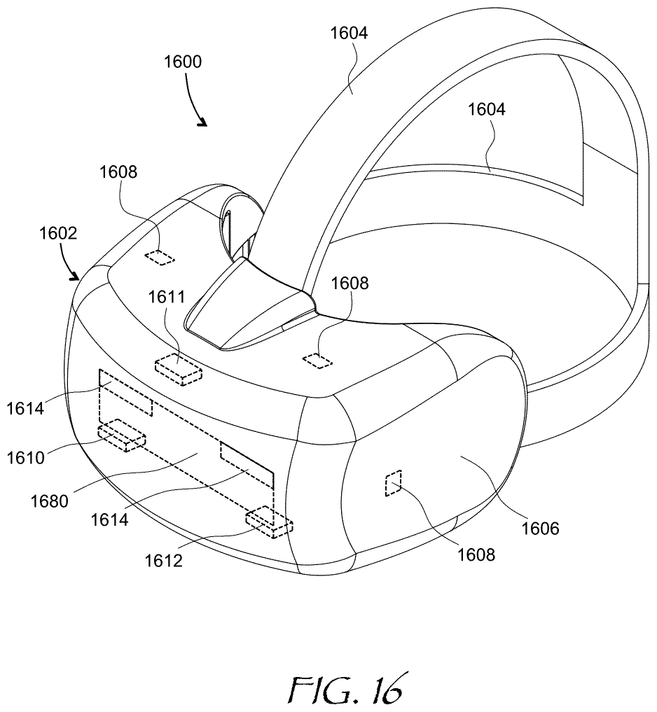

Turning to FIG. 16, an HMD 1600 is an example of an AR/VR wearable display system which encloses the user's face, for a greater degree of immersion into the AR/VR environment. The HMD 1600 may generate the entirely virtual 3D imagery. The HMD 1600 may include a front body 1602 and a band 1604 that can be secured around the user's head. The front body 1602 is configured for placement in front of eyes of a user in a reliable and comfortable manner. A display system 1680 may be disposed in the front body 1602 for presenting AR/VR imagery to the user. The display system 1680 may include any of the display devices and illuminators disclosed herein. Sides 1606 of the front body 1602 may be opaque or transparent.

In some embodiments, the front body 1602 includes locators 1608 and an inertial measurement unit (IMU) 1610 for tracking acceleration of the HMD 1600, and position sensors 1612 for tracking position of the HMD 1600. The IMU 1610 is an electronic device that generates data indicating a position of the HMD 1600 based on measurement signals received from one or more of position sensors 1612, which generate one or more measurement signals in response to motion of the HMD 1600. Examples of position sensors 1612 include: one or more accelerometers, one or more gyroscopes, one or more magnetometers, another suitable type of sensor that detects motion, a type of sensor used for error correction of the IMU 1610, or some combination thereof. The position sensors 1612 may be located external to the IMU 1610, internal to the IMU 1610, or some combination thereof.

The locators 1608 are traced by an external imaging device of a virtual reality system, such that the virtual reality system can track the location and orientation of the entire HMD 1600. Information generated by the IMU 1610 and the position sensors 1612 may be compared with the position and orientation obtained by tracking the locators 1608, for improved tracking accuracy of position and orientation of the HMD 1600. Accurate position and orientation is important for presenting appropriate virtual scenery to the user as the latter moves and turns in 3D space.

The HMD 1600 may further include a depth camera assembly (DCA) 1611, which captures data describing depth information of a local area surrounding some or all of the HMD 1600. The depth information may be compared with the information from the IMU 1610, for better accuracy of determination of position and orientation of the HMD 1600 in 3D space.

The HMD 1600 may further include an eye tracking system 1614 for determining orientation and position of user's eyes in real time. The obtained position and orientation of the eyes also allows the HMD 1600 to determine the gaze direction of the user and to adjust the image generated by the display system 1680 accordingly. The determined gaze direction and vergence angle may be used to adjust the display system 1680 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1602.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display apparatus comprising:
a collimator having object and image planes;
a display panel comprising an array of pixels for providing an image in linear domain at the object plane; and
a redistributor comprising an array of light-redirecting features,
wherein:
the collimator is configured for converting the image in linear domain at the object plane into an image in angular domain at the image plane, wherein a beam of light from a pixel of the display panel has a first dependence of a beam coordinate at the image plane upon a pixel coordinate at the object plane when the display panel is illuminated with light having a spatially uniform angular distribution of brightness; and
the light-redirecting features of the redistributor are configured to convert the spatially uniform angular distribution of brightness of light illuminating the display panel into a spatially non-uniform angular distribution of brightness for lessening the first dependence.

2. The display apparatus of claim 1, further comprising an illuminator for providing the light having the spatially uniform angular distribution of brightness, wherein the redistributor is disposed downstream of the illuminator for converting the spatially uniform angular distribution of brightness into the spatially non-uniform angular distribution of brightness of the light illuminating the display panel.

3. The display apparatus of claim 1, wherein the collimator comprises a pancake lens.

4. The display apparatus of claim 1, wherein the array of light-redirecting features of the redistributor comprises concentric circular ridges extending from a substrate.

5. The display apparatus of claim 4, wherein the concentric circular ridges have triangular cross sections, a steepness of the triangular cross sections increasing with a distance from a common center of the concentric circular ridges.

6. The display apparatus of claim 5, wherein each triangular cross-section comprises a first side forming a first angle with a plane of the substrate, the first angle increasing with a distance from a center of the concentric circular ridges, and a second side joining the first side at a crest of the triangular cross-section, the second side forming a second angle with the plane of the substrate, the second angle being greater than 80 degrees and less than 89.9 degrees.

7. The display apparatus of claim 6, wherein the second angle is greater than 87 degrees and less than 89 degrees.

8. The display apparatus of claim 6, wherein at least one of:
a height of each triangular cross section is no greater than 30 micrometers;
a pitch of the array of light-redirecting features is between 5 micrometers and 100 micrometers;
the pitch varies with the distance from the center, with a minimum variation of 30 nanometers between neighboring ridges; or
the redistributor comprises a flat central region of a uniform thickness.

9. A matched collimator-redistributor pair comprising:
a collimator for converting a cone of light from each pixel of a display panel at an object plane of the collimator into a corresponding collimated beam at an image plane of the collimator, wherein a coordinate of the collimated beam at the image plane has a dependence on a coordinate of a corresponding pixel at the object plane; and
a redistributor comprising an array of light-redirecting features for providing a lateral distribution of a local direction of illuminating light of an illuminator for illuminating the display panel to lessen the dependence of the coordinate of the collimated beam at the image plane on the coordinate of the corresponding pixel at the object plane.

10. The matched collimator-redistributor pair of claim 9, wherein the coordinate of the collimated beam at the image plane has the dependence on the coordinate of the corresponding pixel at the object plane when all cones of light from all pixels of the display panel have cone axes parallel to one another, wherein the redistributor is configured to reorient the cone axes of at least some of the pixels to lessen the dependence of the coordinate of the collimated beam at the image plane on the coordinate of the corresponding pixel at the object plane.

11. The matched collimator-redistributor pair of claim 9, wherein the collimator comprises a pancake lens.

12. The matched collimator-redistributor pair of claim 9, wherein the array of light-redirecting features of the redistributor comprises concentric circular ridges extending from a substrate.

13. The matched collimator-redistributor pair of claim 12, wherein the concentric circular ridges have triangular cross sections, a steepness of the triangular cross sections increasing with a distance from a common center of the concentric circular ridges.

14. The matched collimator-redistributor pair of claim 13, wherein each triangular cross-section comprises a first side forming a first angle with a plane of the substrate, the first angle increasing with a distance from a center of the concentric circular ridges, and a second side joining the first side at a crest of the triangular cross-section.

15. The matched collimator-redistributor pair of claim 14, wherein at least one of:
the second angle is greater than 87 degrees and less than 89 degrees;
a height of each triangular cross section is no greater than 30 micrometers;
a pitch of the array of light-redirecting features is between 5 micrometers and 100 micrometers;
the pitch varies with the distance from the center, with a minimum variation of 30 nanometers between neighboring ridges; or
the redistributor comprises a flat central region of a uniform thickness.

16. A redistributor for converting a first lateral angular distribution of brightness of an illuminator into a second, different lateral angular distribution of brightness of the illuminator, the redistributor comprising:
a transmissive substrate; and
a first array of refractive features extending from the transmissive substrate;
wherein at least one of:
the redistributor further comprises a flat central region of a uniform thickness; or
the refractive features of the first array have triangular or convex cross sections with a steepness of the cross sections increasing with a distance from a center of the transmissive substrate.

17. The redistributor of claim 16, wherein the first array of refractive features comprises concentric circular ridges.

18. The redistributor of claim 17, wherein the refractive features of the first array have triangular cross sections, a steepness of the triangular cross sections increasing with a distance from a common center of the concentric circular ridges.

19. The redistributor of claim 18, wherein each triangular cross-section comprises a first side forming a first angle with a plane of the transmissive substrate, the first angle increasing with a distance from a center of the concentric circular ridges, and a second side joining the first side at a crest of the triangular cross-section and forming a second angle with the plane of the transmissive substrate.

20. The redistributor of claim 19, wherein at least one of:
the second angle is greater than 87 degrees and less than 89 degrees;
a height of each triangular cross section is no greater than 30 micrometers;
a pitch of the first array is between 5 micrometers and 100 micrometers; or
the pitch varies with the distance from the center, with a minimum variation of 30 nanometers between neighboring ridges.
